(19) United States
(12) Patent Application Publication
(10) Pub. No.: US 2008/0134846 A1
(43) Pub. Date: Jun. 12, 2008

(54) Tool assembly comprising handle including driver tool

(76) Inventors: Brian S. Potempa, Oak Creek, WI (US); Michael M. Potempa, Oak Creek, WI (US); Craig S. Serio, New Berlin, WI (US); Michael Toll, Shorewood, WI (US)

Correspondence Address: TAFT, STETTINIUS & HOLLISTER LLP, SUITE 1800, 425 WALNUT STREET, CINCINNATI, OH, 45202-3957, US

(21) Appl. No.: 11/986,305

(22) Filed: Nov. 20, 2007

Related U.S. Application Data
(63) Continuation of application No. PCT/US05/18454, filed on May 25, 2005.

(51) Int. Cl. B25G 1/00; B25G 1/04; B25B 23/12; B26B 3/00

(52) U.S. Cl. 81/489; 16/427; 81/451; 30/169

(57) ABSTRACT

A tool assembly comprising a handle having first and second sides, first and second ends, and a channel portion. A resiliently biased driver assembly is movably retained within the handle. The driver assembly can be activated from a closed condition to an open condition by pressing a button.

### CROSS-REFERENCE TO RELATED APPLICATIONS

This application is a continuation that claims priority under 35 U.S.C. §120 of Patent Cooperation Treaty Application Serial No. PCT/US05/18454 filed on May 25, 2005, entitled “Tool Assembly Comprising Handle Including Driver Tool”, the disclosure of which is hereby incorporated by reference.

### FIELD OF THE DISCLOSURE

The disclosure generally relates to utility tools, and specifically relates to tool assemblies comprising handles including driver tools.

### BACKGROUND

It is often useful to have more than one tool immediately at hand. For example, consumers performing routine building maintenance with a hammer often also need to use a driver tool such as a screwdriver. Similarly, consumers using a painting preparation tool such as a paint scraper or a putty knife often also need to use a driver tool in order to prepare a surface for subsequent painting or repair (e.g., when tightening down a drywall screw or adjusting trim, fixtures, or window hardware).

Normally, the consumer must put down the tool currently in use and subsequently grasp and properly position the driver tool in their dominant hand. For example, when a consumer is applying joint compound with a painting preparation tool and wishes to use a driver tool, the painting preparation tool in use must be put down, and the driver tool must be picked up and properly positioned in the dominant hand before it can be used. Aside from the inconvenience and stress caused by picking up the driver tool, this action can be awkward and dangerous, particularly if the consumer is working on a ladder.

Furthermore, the driver tool often must be retrieved from a location other than where the consumer is performing maintenance. Thus, the consumer must keep track of several tools, and the possibility that one or more of these tools could be dropped or otherwise misplaced is enhanced.

### BRIEF DESCRIPTION OF THE DRAWINGS

FIG. 1 is a perspective view of an exemplary tool including a handy constructed in accordance with the teachings of the disclosure.

FIG. 2 is an exploded perspective view of the handle illustrated in FIG. 1.

FIG. 3A is a side view of a driver assembly.

FIG. 313 is an end view of the driver assembly of FIG. 3A.

FIG. 4A is a side view of an exterior portion of a first retaining bracket.

FIG. 4B is a side view of an exterior portion of a second retaining bracket.

FIG. 5A is a side perspective view of an interior portion of the first retaining bracket shown in FIG. 4A.

FIG. 5B is a side perspective view of an interior portion of the second retaining bracket shown in FIG. 4B.

FIG. 6 is a side perspective view of a button.

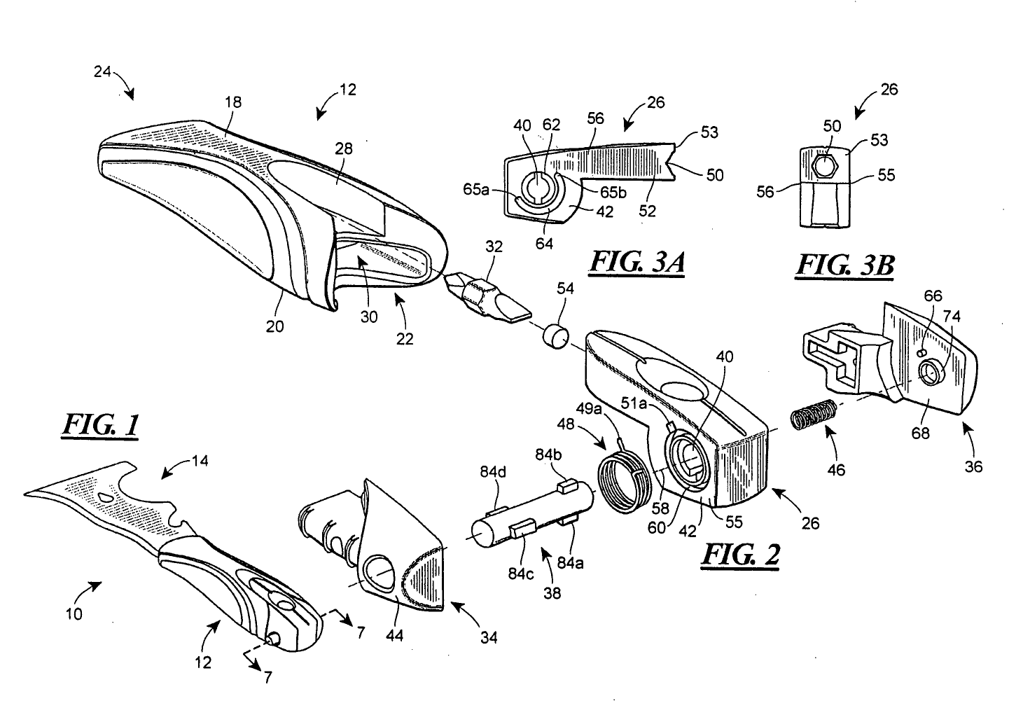

FIG. 7 is a partial cross-sectional view of the handle taken along line 7-7 of FIG. 1.

FIG. 8 is a perspective view of an exemplary driver tool bit.

FIG. 9 is a partially cut-away perspective view of the driver assembly.

### DETAILED DESCRIPTION

The disclosure provides a tool handle including a driver tool movably retained therein and tools comprising same. The driver tool can be actuated from a closed condition where the driver tool is received within the handle (and thus does not interfere with the consumer's use of the tool mounted or otherwise attached thereto) to an open condition where the driver tool outwardly projects from a butt end of the tool handle by depressing a button that protrudes through the handle. In the open condition, the driver tool generally projects from the handle butt end at an angle (defined relative to the longitudinal handle axis) between about 25 degrees and about 240 degrees.

Referring now to FIG. 1, an exemplary tool 10 including a handle 12 constructed in accordance with the teachings of the disclosure is shown. The tool 10 is illustrated and described herein as a painting preparation tool (e.g., a putty knife or a paint scraping device), but the tool 10 may be any type of tool including but not limited to a hammer, a paint brush, a wire brush, a flashlight, and a fishing pole. As exemplified in the drawing figures, the tool 10 is a paint preparation tool including a blade 14 connected to a generally elongated handle 12. The blade 14 includes several scraping surfaces including but not limited to straight surfaces and curvilinear surfaces. Additionally, the blade 14 may include other utility surfaces including but not limited to a nail remover, a paint roller cleaning surface, and a bottle opener.

Referring now to FIG. 2, the handle 12 includes first and second sides 18, 20 and first and second ends 22, 24. A driver assembly 26 is movably coupled to the handle 12 at (or generally about) the first end 22, and the blade 14 (or other tool) is coupled to the handle 12 at the second end 24. The handle 12 includes a recessed area 28 in the first side 18 thereof. The recessed area 28 is generally oblong in shape and open proximate the first handle end 22. The recessed area 28 generally receives and substantially contains a portion of the driver assembly 26 (including driver tool bit 32) when the tool 10 is in a closed condition.

The handle 12 can also include at least one aperture 30 in the first end 22. The aperture 30 is illustrated as being slot-like in shape, but the aperture shape may be of various configurations. The opening of aperture 30 generally spans the width of the first end 22 of the handle 12. However, the aperture 30 typically spans only a portion of the height of the first end 22 of the handle 12 when present.

The handle 12 also includes two retaining brackets 34, 36. The retaining brackets 34, 36 movably retain the driver assembly 26 within the handle 12 such that the driver assembly 26 can be actuated from a closed condition to an open condition. As previously described, the driver assembly 26 can be actuated from a closed condition to an open condition by depressing a button 38.

The button 38 is shown as being generally cylindrical, but other shapes are possible. The button 38 is partially received in a bore 40 disposed in a base 42 of the driver assembly 26 such that the button 38 protrudes past an outer surface 44 of the first retaining bracket 34. The button 38 is generally biased past the outer surface 44 of the first retaining bracket 34 by one or more biasing elements. A first biasing element, shown as first spring 46, disposed between the button 38 and the second retaining bracket 36 biases the button 38 outwardly.

A second biasing element, shown as a second spring 48, disposed between the driver assembly 26 and the first retaining bracket 34 biases the driver assembly 26 to an open condition (i.e., where the driver assembly 26 extends outwardly from the first handle end 22) in the exemplified embodiment shown in FIG. 2. Although shown as a compression spring and a torsional spring, respectively, the biasing elements 46, 48 may alternatively be any suitable biasing elements including but not limited to leaf springs, compression springs, torsional springs, magnets, and rubber bands.

The second spring 48 typically includes first and second ends 49a, 49b. The first end 49a of the second spring 48 is generally received by a first spring slot 51a formed in the first side 55 of the driver assembly 26. The second end 49b is received by a second spring slot 51b (shown in FIG. 5A) formed on an inner surface 78 of the first retaining bracket 34. The first and second spring slots secure the first and second ends 49a, 49b of the second spring 48, thereby preventing relative movement between the first and second ends 49a, 49b of the spring 48, the driver assembly 26, and the first retaining bracket 34.

When activated to the open condition, the driver assembly 26 may extend from the first handle end 22 at any angle (relative to the longitudinal handle axis) between approximately 25 degrees to approximately 240 degrees depending on consumer preferences. In two such embodiments, the driver assembly 26 extends from the first handle end 22 at an approximately 90 degree angle and at an approximately 180 degree angle relative to the longitudinal axis of the handle 12. Further, the driver assembly 26 may include a plurality of open conditions wherein the driver assembly 26 extends from a stopping point at a plurality of angles between approximately 25 degrees and approximately 240 degrees. For example, the driver assembly 26 can be locked into a fixed position relative to the handle 12, and extend at 90, 120, and 180 degree angles relative to the longitudinal handle axis.

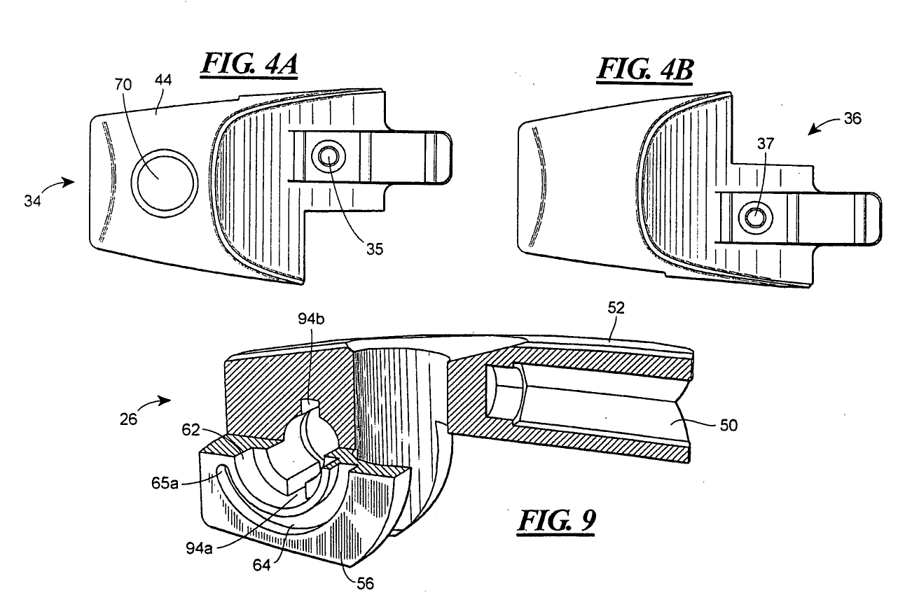

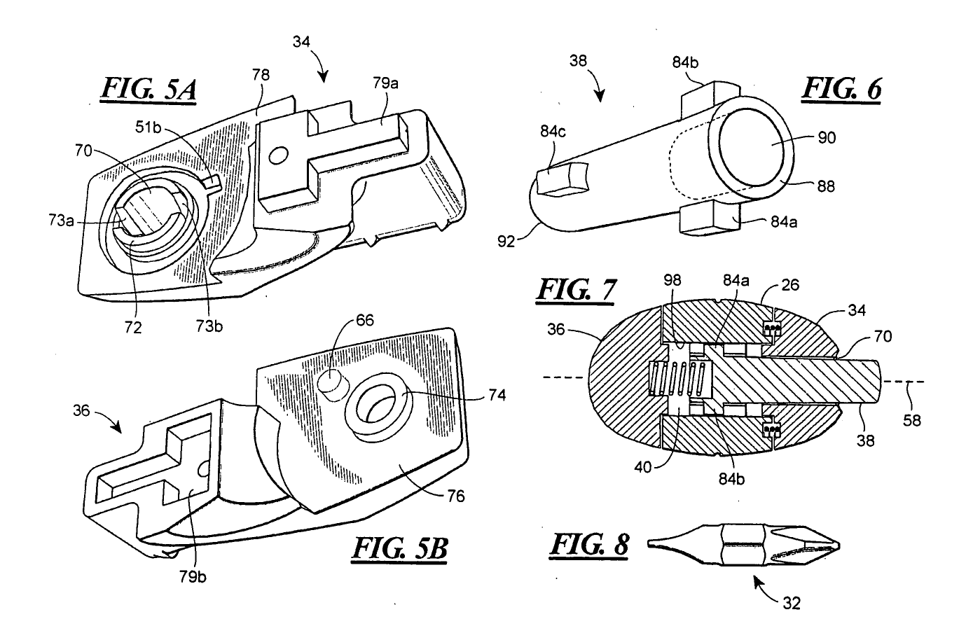

The driver assembly 26 includes a hole 50 at a distal end 53 of an extension 52 (shown in FIGS. 3A and 3B). The hole 50 is generally dimensioned to receive the driver tool bit 32. In one embodiment, a magnet 54 is disposed in the hole 50 to retain the driver tool bit 32 therein. Ball bearings (not shown) disposed on an interior surface of the hole 50 could similarly be used. Alternatively, the driver tool bit 32 may be integrally formed with the extension 52 of the driver assembly 26.

The driver assembly 26 is shown as having a pistol shape, but other shapes may be used. The driver assembly 26 includes a bore 40 as previously described. The bore 40 extends laterally from a first side 55 to a second side 56 of the driver assembly 26. The bore 40 is shown as being generally cylindrical in shape, but other shapes are possible. The bore 40 center generally defines a pivot axis 58 about which the driver assembly 26 pivots when moving between the open and closed conditions. The bore 40 also includes two annular channels 60, 62 disposed at first and second ends of the bore 40, respectively. As best shown in FIG. 9, the driver assembly 26 includes a semi-circular channel 64 partially surrounding the bore 40 on the second side 56 of the driver assembly 26.

As previously discussed, the handle 12 includes two retaining brackets 34, 36. FIG. 4A illustrates an exterior side view of the first retaining bracket 34. The first retaining bracket 34 has a hole 70 running laterally therethrough for receiving a portion of the button 38. The button 38 generally protrudes outwardly from the hole 70 beyond the outer surface 44 of the first retaining bracket 34. Thus, a consumer has access to and can depress the button 38. The button 38 is movable along an axial direction within the hole 70, and is biased outwardly by the spring 46 (or other biasing element), as previously described. A fastener hole 35 runs through the first retaining bracket 34 and accepts a fastener (not shown) to secure the first retaining bracket 34 to the second retaining bracket 36 through the hole 37 as shown in FIG. 4B. The retaining brackets 34, 36 could be joined together with any acceptable fastener means and/or the pair of retaining brackets 34, 36 could be adhered to the handle 12 by an adhesive.

The second retaining bracket 36 is essentially a mirror image of the first retaining bracket 34, and thus has substantially the same size and shape as the first retaining bracket 34. However, the brackets 34, 36 do not have to be mirror images. Furthermore, the brackets 34, 36 may be a retention unit of single, unitary construction provided that the retention unit captures the driver assembly 26 and permits its movable retention within the handle 12, as described herein. With respect to the illustrated embodiment, the second retaining bracket 36 lacks the button hole 70 of the first retaining bracket 34. Other differences between the first and second retaining brackets 34, 36 will be discussed with reference to FIGS. 5A and 5B below.

FIG. 5A illustrates an interior side view of the first retaining bracket 34. Surrounding the button hole 70 is a first annular ring 72 extending outwardly from the inner surface 78 of the first retaining bracket 34. The annular ring 72 is shown as including two notches 73a, 73b, which are disposed approximately 180 degrees apart. More or less notches (73a, 73b) may be disposed along the first annular ring 72. The annular channel 60 of the bore 40 receives the first annular ring 72, thereby stabilizing the driver assembly 26 within the first retaining bracket 34. Additionally, the inner surface 78 of the first retaining bracket 34 includes a generally “T” shaped key portion 79a extending outwardly from the inner surface 78 of the first retaining bracket. The key portion 79a is sized and shaped to mate with a generally “T” shaped recessed portion 79b formed on the inner surface 76 of the second retaining bracket as shown in FIG. 5B. Any suitable complimentary shapes may be used for the key portion 79a and the recessed portion 79b. When mounted in the aperture 30, the key portion 79a and the recessed portion 79b are partially disposed within the aperture 30 such that the brackets 34, 36 are coupled to the handle 12. However, the retaining brackets 34, 36 could be adhered to the handle 12 by an adhesive.

A second annular ring 74 and a stop post 66 extend outwardly from the inner surface 76 of the second retaining bracket 36. The second annular ring 74 performs a function similar to the first annular ring 72 on the first retaining bracket 34. The annular channel 62 (shown in FIG. 9) receives the second annular ring 74, thereby stabilizing the driver assembly 26 within the second retaining bracket 36. The semi-circular channel 64 slidably receives the stop post 66. The stop post 66 slides within the semi-circular channel 64 of the driver assembly 26 when the driver assembly 26 is pivoted, for example, from the closed condition to the open condition. However, in the open condition, the stop post 66 contacts the end 65a of the semicircular channel 64, thereby stopping the pivoting movement of the driver assembly 26.

FIG. 6 is a perspective view of the button 38. The button 38 is generally cylindrical in shape, and comprises one or more ribs 84a, 84b, 84c, 84d (84d is shown in FIG. 2) extending outwardly therefrom. In the exemplified embodiment, two ribs 84a, 84b are disposed proximate a first end 88 of the button 38, and two ribs 84c, 84d are disposed proximate a second end 92 of the button 38. Furthermore, the button 38 includes a cylindrical hole 90 disposed at the first end 88. Various notches 94a, 94b (shown in FIG. 9) in the bore 40 receive two ribs 84a, 84b when the driver assembly 26 is in the open or closed conditions. In this manner, the ribs 84a, 84b and the notches 94a, 94b, lock the driver assembly 26 in the chosen condition. Additionally, the notches 73a, 73b of the annular ring 72 receive two ribs 84c, 84d. The notches 73a, 73b are separated by the same number of degrees as ribs 84c, 84d of the button 38. In this manner, the ribs 84a, 84b, 84c, 84d, and the notches 94a, 94b, 73a, 73b restrict relative movement of the driver assembly 26 when the driver assembly 26 is in the open and closed conditions.

To activate the driver assembly 26, the consumer pushes the button 38 against the bias provided by the first spring 46. This action slidably disengages the ribs 84a, 84b from the notches 94a, 94b in the bore 40. The ribs 84c, 84d remain engaged with notches 73a, 73b and prevent rotation of the button 38. While the driver assembly 26 is between the open and closed conditions, the button ribs 84a, 84b are slide out of notches 94a, 94b such that they freely ride along annular channel 62 of the bore 40. This sliding action overcomes the bias of the first spring 46, and releases the torsional spring 48, thereby causing the driver assembly to pivot outwardly from the closed condition to the open condition. The configuration of the ribs 84a, 84b and the notches 94a, 94b can be varied such that the driver assembly 26 extends at any suitable angle between approximately 25 degrees and approximately 240 degrees (relative to the handle longitudinal axis), as previously described.

An alternative actuation mechanism (not shown) wherein the button (or similar actuation element such as a pin or lever) is coupled to a surface that interferes with the rotation of the driver assembly 26 could be used to actuate the driver assembly 26 from the closed condition to the open condition. In this embodiment, depressing the button removes the surface that engages a catch surface of a pivot member of the driver assembly, thereby permitting rotation of the driver assembly. Additionally, in this embodiment, the button need not traverse the bore, but can instead extend perpendicular to the longitudinal axis of the handle 12.

FIG. 7 is a partial lateral cross-section of the handle 14 taken along line 7-7 of FIG. 1. FIG. 7 shows that the driver assembly 26 is generally captured or sandwiched between the first retaining bracket 34 and the second retaining bracket 36. The spring 46 is a compression spring and is compressed between the button,38 and the second retaining bracket 36, thereby biasing the button 38 outwardly causing the button 38 to protrude beyond the hole 70 in the first retaining bracket 34. Two of the ribs 84a, 84b, also contact an inner diameter 98 of the bore 40 stabilizing the button 38 in the bore 40. This configuration allows the driver assembly 26 to pivot about the pivot axis 58 from the open condition to the closed condition.

In an alternative embodiment, the driver assembly 26 is also movably retained within the handle 12, but the driver tool bit 32 is aligned toward the first handle end 22. In this embodiment, the driver assembly can also be activated to the open condition upon actuation of button 38, but the driver assembly 26 is not pivoted about pivot axis 58 when moving between the open and closed conditions. Instead, the driver assembly slides out of the handle 16 along the longitudinal axis of the handle when moving between the open and closed conditions. In this embodiment, the second spring 48 may be a compression spring as opposed to the torsional spring 48 shown in FIG. 1.

FIG. 8 illustrates one example of a driver tool bit 32 that may be retained by the hole 50 in the driver assembly 26. In this case, the driver tool bit 32 includes a phillips head driver at one end and a flat head or standard screwdriver at the other end. Of course, any driver type tool may be formed at either end of the driver tool bit 32 including but not limited to a hex wrench, a square drive, an allen wrench, a torx head screw driver, and other similar driving tools. Any suitable driver tool bit 32 shape including but not limited to hexagonal, square, triangular, octagonal, and circular may be used.

FIG. 9 is a partially cut-away perspective view of the driver assembly 26. The notches 94a, 94b extend through the bore 40 easing assembly. Likewise, the semi-circular channel 64 is open at a second end 65b to receive the stop post 66 during assembly.

The driver assembly 26, first and second retaining brackets 34, 36, the button 38 and the driver tool bit 32 are preferably manufactured from stainless steel sand [error] casting components, but other materials including but not limited to zinc/galvanized metals, aluminum, alloy die castings, plastics, and ceramics may be used. Additionally, metal parts of this embodiment are typically manufactured by die casting, but other methods including but not limited to milling, turning, forging, and press working may be used.

The handle 12 is preferably manufactured from thermoplastics and may include a rubberized overmold layer to provide a gripping surface. Alternatively, the handle 12 may be constructed from other materials including but not limited to metal, wood, and ceramics. Additionally, the various handle components are typically manufactured by injection molding, but other methods may be used including but not limited to extrusion, blow molding, and compression molding.

Although certain functions and features have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. a tool assembly, comprising:
a handle having first and second sides, first and second ends, and a channel;
and, a driver assembly having a base with a bore and a resiliently biased button partially received in and projecting from the bore, an extension, and a driver tool bit extending from the extension, the driver assembly coupled to the handle and movable between a closed condition wherein the driver assembly is at least partially disposed within the channel and an open condition wherein at least the driver tool bit projects outwardly from the handle, the button being selectively movable to release the driver assembly from the closed condition to the open condition.

2. The tool assembly of claim 1, wherein the driver assembly is resiliently biased to the open condition and selectively retained against a biasing force in the closed condition.

3. The tool assembly of claim 1, wherein the channel is disposed on the first handle side proximate the first handle end.

4. The tool assembly of claim 1, wherein a tool is coupled to the second handle end.

5. The tool assembly of claim 4, wherein the tool is selected from a group consisting of a scraping tool, a putty knife, a hammer, and a flashlight.

6. The tool assembly of claim 1, wherein the extension includes a hole at a distal end thereof and the driver tool bit is removably disposed in the hole and selectively replaceable with another driver tool bit.

7. The tool assembly of claim 6, wherein a magnet is disposed within the hole and the driver tool bit includes a magnetically attractive material.

8. The tool assembly of claim 1, wherein the driver tool bit is selected from the group consisting of a phillips head screwdriver, a flat head screwdriver, a square head screwdriver, a hexagonal head screwdriver, a torx head screwdriver, and an adjustable wrench.

9. The tool assembly of claim 10, wherein the driver assembly pivots through at least about 25 degrees between the closed and open conditions.

10. A scraping tool assembly, comprising:
a handle having first and second sides, first and second ends, and a channel;
a scraping blade mounted to and extending from the handle second end;
a driver tool pivotably attached to the handle first end and movable between a closed condition wherein the driver tool is at least partially disposed within the channel and an open condition wherein a portion of the driver tool projects outwardly from the handle, and,
a resiliently biased, selectively movable button, the button being movable to release the driver tool from the closed condition to the open condition.

11. The scraping tool assembly of claim 10, wherein the driver tool is resiliently biased to the open condition and selectively retained against a biasing force in the closed condition.

12. The scraping tool assembly of claim 10, wherein the driver tool pivots through at least about 25 degrees between the closed and open conditions.

13. A tool assembly, comprising:
a handle having first and second sides, first and second ends, a recess on the first side proximate the first end, and an aperture at the first end;
a resiliently biased driver assembly movably retained in the aperture, the driver assembly having a base, an extension, and a resiliently biased button;
a driver tool bit removably disposed in a hole at a distal end of the extension;
a scraping blade extending from the handle second end,
wherein the driver tool bit is substantially disposed within the recess in a closed condition,
the driver assembly is pivotably retained in the aperture and is resiliently biased to an open condition in which the driver tool bit is disposed out of the recess and extends outwardly from the handle,
actuating the button pivots the driver assembly from the closed condition to the open condition.

14. The tool assembly of claim 13, wherein the button comprises a plurality of ribs and a driver assembly bore includes a plurality of notches that releasably receive one or more of the ribs.
